(19) United States
(12) Patent Application Publication
(10) Pub. No.: US 2013/0279804 A1
(43) Pub. Date: Oct. 24, 2013

(54) DUAL TRANSFORM LOSSY AND LOSSLESS COMPRESSION

(71) Applicant: Daniel KILBANK, Bethesda, MD (US)

(72) Inventors: Daniel Kilbank, Bethesda, MD (US); Tam-Anh CHU, Great Falls, VA (US)

(21) Appl. No.: 13/646,923

(22) Filed: Oct. 8, 2012

Related U.S. Application Data
(63) Continuation of application No. 13/453,631, filed on Apr. 23, 2012, now abandoned.

(51) Int. Cl. G06T 9/00

(52) U.S. Cl. CPC G06T 9/007
USPC 382/166

(57) ABSTRACT

A system and method for compression of video data uses digital processors to transform the data to a more compressed format. After preprocessing, a KL (Karhunan-Loève) transform is used to treat an array of pixels as a series of vectors transformed to a new set of basis vectors selected so that the data vectors (now represented by coordinates with respect to the transformed axes) lie closest to the transformed axes. A number of the axes lying closest to the data is selected, and the vectors are projected onto the subspace spanned by those axes. Those components extending into the orthogonal subspace are retained as a separate (second) data set, and a second GS (“Gram-Schmidt) compression is applied to those components. By suppressing portions of the data generated in the GS transformation, lossy transformations are efficiently accomplished. The data may also be preprocessed and where different parameter values may be selected for the pre-processing, the system may be tried for different parameter values and the result with the lowest entropy selected.

### FIELD OF THE INVENTION

The present invention concerns processing for both lossy and lossless compression and decompression of data. In particular it implements compression via dual transform filters particularly for video data.

### BACKGROUND OF THE INVENTION

The digitization of analog data can be accomplished without any loss of information by sampling the data at a frequency that is at least twice as great as the frequencies contained in the data. Such high frequency sampling, however, produces a very large quantity of digital data that often has many redundancies. For example, image data often represents large areas that are identical such as background, or regions that slowly vary in image characteristics until something like an edge is reached. Also, sequences of images, such as in video, may have regions that are identical or slowly changing from frame to frame. These characteristics of the data provide an opportunity for data compression.

Data compression cart be usefully divided into lossless compression or lossy compression. Where lossy compression is employed, the utility of the data is minimally compromised by the loss of a small quantity of the data. This is a widely diversified field, as this loss can be discriminate or non-discriminate; thus the methods employed to allow the loss of data should be thoroughly bound and constrained. For example in reproduction of sound or images a certain amount of fallout can be tolerated. For software code, on the other hand, even the loss of one bit of data can have severe consequences and lossless compression is essential.

Internet protocols recognize the distinction between lossy and lossless protocols as well. In IP/TCP protocols every bit of data is accounted for by requiring redundancy during transmission. On the other hand, in the IP/UDP protocols not every data packet is guaranteed to be received by the intended recipient.

A compression scheme has an efficiency that is measured by comparing the bit length of the compressed data with the entropy of the uncompressed data. That entropy H is defined as

$${lim}_{n \to ∞} - \frac{1}{n} Σ P ( {X}_{1} , … , {X}_{n} ) {log}_{2} P ( {X}_{1} , … , {X}_{n} )$$

where X₁, . . . , Xn are possible values for n data bits, the sum is over all possible values for the Xs and P is the probability of a particular choice of Xs.

In U.S. Pat. No. 7,412,104, there was disclosed a method for lossless data compression of digital data by first employing a lossy transformation to compress the data, where the lossy transformation was a function of parameters. That first compression was then reversed to provide a lossy version of the initial data. The difference between the initial data and the reverse transformed data, termed difference data, was then determined. The sum of the entropy of the difference data and the entropy of the lossy transformed data was minimized as the parameters of the lossy transformation were varied. The values of the parameters that minimized the sum of entropies were then used to provide the optimal lossy transformed data and the difference data. The combination of those two sets of data then represented a reversible lossless transformation of the initial data.

### BRIEF DESCRIPTION OF THE PRESENT INVENTION

The present invention is particularly suited for the compression of video data using digital processors to carry out the transformation of the data to a more compressed format. After preprocessing, a KL (Karhunan-Loève) transform is used to treat an array of pixels as a series of vectors. The array is decomposed into layers each comprising single bits in a rectangular arrangement (N rows by M columns, where N may equal M) which the transform treats as N data vectors each of dimension M. Since the data vectors each have M components they define points in an M dimensional Euclidean space. The KL transform is a linear transformation of the basis vectors of that space to a new set of basis vectors selected so that the data vectors (now represented by coordinates with respect to the transformed axes) lie closest to the transformed axes. The new basis vectors are obtained by the solution of an eigenvalue equation. A selected number of these axes lying closest to the data are selected, namely those associated with the largest eigenvalues, and the vectors are projected onto the subspace spanned by those axes. This reduces the dimensionality of the vector space to that of the subspace. The coordinates of the projections of the vectors then substitute for the coordinates of the original vectors and constitutes (because the dimensionality has been reduced) a compression of the data. There is a loss of information as a result of this projection and compression. Every vector loses components due to the projection into a subspace of the original vector space; the components extending into an orthogonal subspace are not represented in the compression.

in the present invention, those components extending into the orthogonal subspace are retained as a separate (second) data set, and a second compression is applied to those components. Since the KL transformation and the solution of its attendant eigenvalue equation is very computationally intensive, a different less complex calculation is utilized for those components, namely a GS transform. The second data now being transformed is not likely to have the same relationships between data points as the original data. For example the original data may represent an image, so that quasi-uniform areas are expected between boundaries, and that may not be true for the second data. Noise, for example, is more likely to reside in the second data. As a result there is not the same advantage to be obtained from using a KL transformation on the second data, which after all is a way to take advantage of correlations in the data. The details lost by projection during the KL transformation are however preserved in the second transformation. The GS transformation is entirely reversible and allows reconstitution of the full dimensionality of the vectors in KL coordinates. With the full vector set, the KL transformation is also reversible so the joint transformation can be lossless if every element orthogonal to the KL subspace is preserved. By suppressing portions of the data generated in the GS transformation, lossy transformations are efficiently accomplished.

Prior to any of these transformations, the data may be pre-processed to take advantage of particular symmetries of the data. For example, preprocessing may involve comparison of values for certain individual pixels based on averages of patterns of neighboring pixels. Where the averages correctly predict the individual values, that may be noted and the individual values suppressed, thereby reducing the quantity of data. Where different parameter values may be selected for the pre-processing, the system may be tried for different parameter values and the result with the lowest entropy selected.

### BRIEF DESCRIPTION OF THE DRAWINGS

FIG. 1 depicts a flow chart for the present invention.

FIG. 2 depicts an arrangement for parallel processing employed in embodiment, of the present invention.

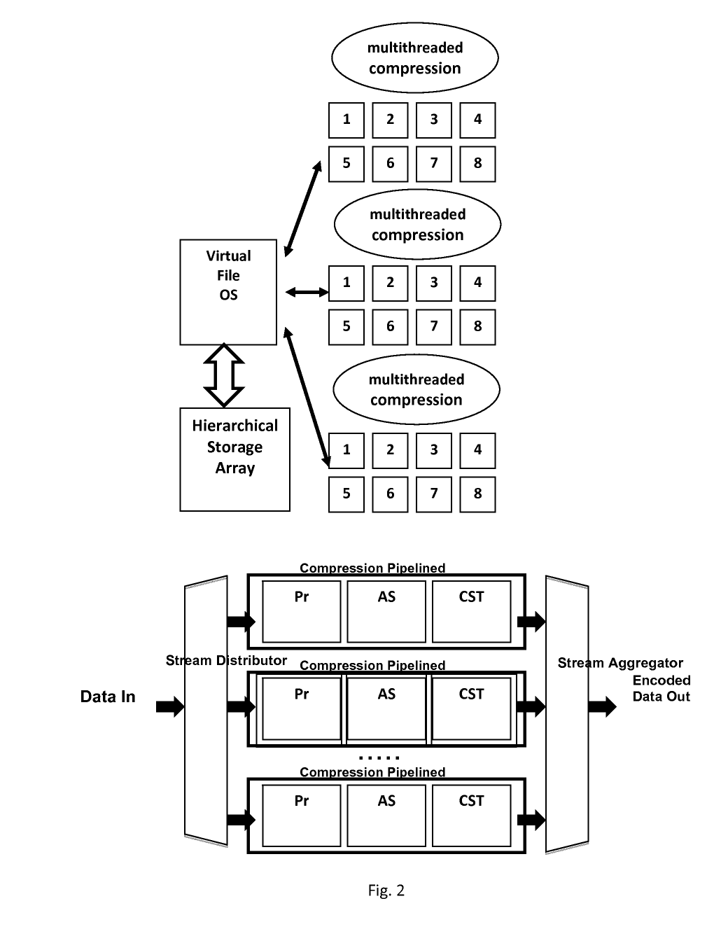

### DETAILED DESCRIPTION OF PREFERRED EMBODIMENTS

The present invention provides an improved data compression system. An embodiment will be described for the compression of raster graphics images. The invention is however suitable for other data types. A raster graphics image may be a data file or structure representing a generally rectangular grid of pixels. The color of each pixel is defined in an RGB color space, comprising three planes of bytes. There are no actual limitations on the number of color planes or color space, it is extensible within the algorithm. Additional planes may be added to visible color such as opacity or infrared. An image with only grey scale pixels only requires a single plane; an image with only black and white requires only a single bit for each pixel. A bitmap corresponds bit for bit with an mage displayed on a screen, probably in the same format as it would be stored in the display's video memory or maybe as a device-independent bitmap. A bitmap is characterized by the width and height of the image in pixels and the number of bits per pixel, which determines the number of colors it can represent.

A colored raster image (a “pixmap”) will usually have pixels with between one and sixteen bits for each of the red, green, and blue components, though other color encodings are also used, such as four- or eight-bit indexed representations that use vector quantization on the (R, G, B) vectors. The green component sometimes has more bits than the other two to cater for the human eye's greater discrimination in this, component.

The quality of a raster image is determined by the total number of pixels (resolution), and the amount of information in each pixel (often called color depth), and the number of color planes. Because it takes a large amount of data to store a high-quality image, data compression techniques are often used to reduce this size for images stored on disk.

Data compression relies on structure that exists within the data. For example, in the case of data representing graphic images, the data in many regions does not change abruptly until one reaches an edge of an image component. This inherent structure implies that it may be more economical to describe the changes in data than the data themselves. Since the changes are likely to be small and smoothly varying they may be approximated by linear functions, just as any smoothly varying function may in small regions be approximated by a value and a first derivative. Transformation techniques that rely on correlation functions can pick out structures that may not be apparent or even easily described.

Two filters employing transform methods are combined in a synergistic manner to provide a prediction of the data by selecting elements in a first KL transform step. The second filter method is the Gram-Schmidt (her in “GS”) method for extracting an orthogonal basis from an arbitrary basis. Instead of performing a lossy transform (as described in U.S. Pat. No. 7,412,104) followed by normalization of data, the data discarded by the first filter is sent to an artificially constructed color plane that is treated as an additional color plane for the second, parallel transform. This second set of data comprises a raster that is a combination of a zeroed out color plane and elements that are discarded from the KL transform and mapped to this plane for the purpose of correlation and to capture and compare more of the original data set as part of the basis for the second transform. As the image is broken into 8×8 blocks, (block sizes can be variable) two transforms work on two independent fields of predicted data and the introduced additional “zero value plane”. This allows the GS transform to work in parallel with the KL transform and introduces a second set of filtering dynamics. Both transforms produce a unitary transformed set of data as a compressed file. Recombination of the resulting data can be accomplished by information contained within the compressed file.

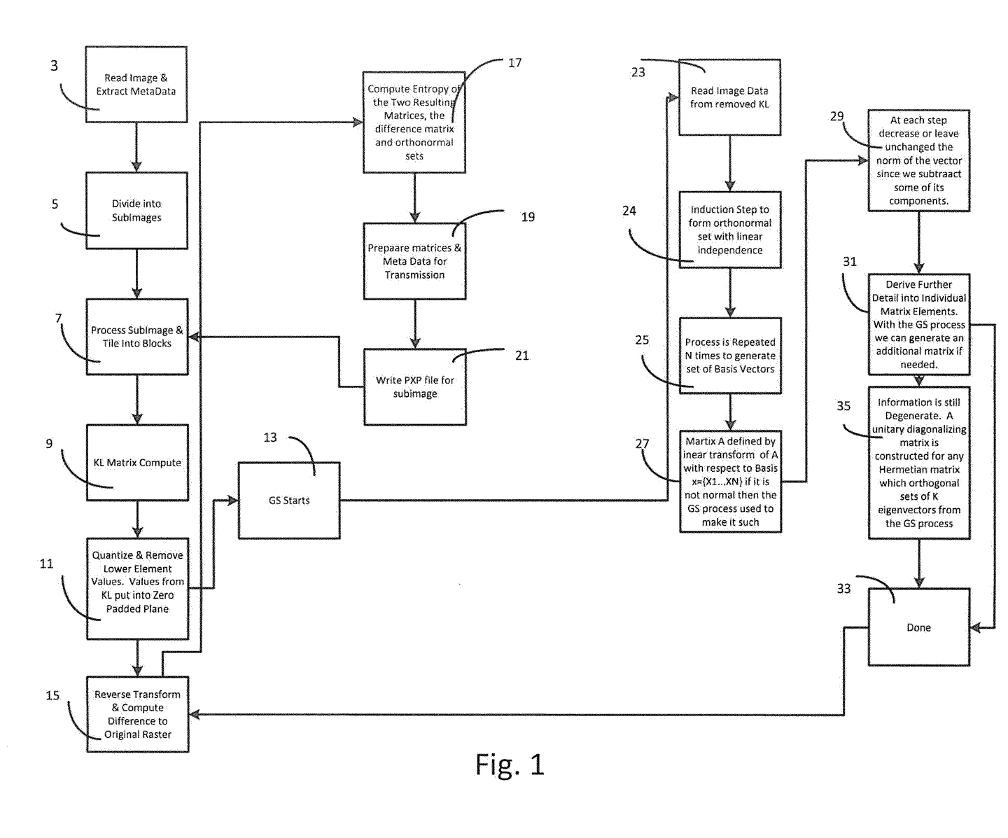

As shown in FIG. 1, a number of stages are involved in the transform coding of the data. As part of preprocessing of the data, the data file is read 3, and metadata extracted. The data is divided into subimages 5 and processed into blocks 7 of a uniform size. In a preferred embodiment, during the pre-processing state the data is divided into blocks and replaced by predictive values in one case and filters in the second with the deviations of the original data from the predictive value and the filtered value. Both the division into blocks and the method for calculating the predictive/filter values are subject to adjustable parameters. In this preferred embodiment the filtered algorithm performs an N-point edge detection of each block to set the filter parameters (where N is an integer greater than 1). Examples are the block dimensions and the method of prediction. The entropy of the data formed by different averaging techniques may be calculated and the method of averaging that produces the least entropy utilized.

A KL transform of the data is performed which results in the computation of a KL matrix. The eigenvectors and eigenvalues of the matrix are determined 9 and the matrix is quantized by the removal of the subspace of lower eigenvalue elements 11. The values from the KL transform are put into a plane padded with zeros to replace the suppressed eigenvector values. The KL matrix, which comprises the eigenvectors of the autocorrelation matrix, may be further reduced by replacing by zeros the eigenvector corresponding to the smallest eigenvalue of the KL matrix and sending these values to the artificial zero plane. This process is repeated by reducing the KL matrix by removing the eigenvectors corresponding to successively larger eigenvalues. At each stage the result of the use of such a modified KL matrix is compared by calculating the entropy of the resulting data plus the entropy of the map values, and the best modified KL matrix is employed in the transformation to be compared and correlated to the second transform map which contains the values discarded from the KL but transformed by the GS.

The data that is removed as lower element values (identified by the lower eigenvalues of the KL eigenvalue matrix) is then subjected to a GS transform 13. Meanwhile, in parallel, the KL transformed data is subjected to a reverse transformation and the result compared to the original data 15. The entropies of the KL transformed data and the difference data are computed 17 and compared and the lesser one selected for transmission 19. A file is written 21 for the portion of the data processed so far and one arm of the parallel process returns to process the next subimage into blocks as in step 7.

The GS transform works in parallel 13 after the first n rows of the KL transform matrix are determined. The image data removed from the KL matrix is read 23, and an induction step is performed to form an orthonormal set with linear independence 24. This last process step 24 is repeated as often as necessary 25 to generate a set of basis vectors. This is combined with the reduced KL matrix to increase fully or slightly the dimensionality of the transformed data. If the dimensionality is fully restored the transformation will be lossless; otherwise it will be lossy. (This is a defined process, not a random event) At each step of producing the transformed matrix of data the norm of the vectors may be decreased or other details stored in the matrix elements 31. The transformation of the data may be taken as complete at this point 33 or further transformed into a diagonalized matrix. The process then repeats for the next portion of the data 7 until the data is exhausted and the file 21 transmitted. When the optimal number is achieved from both orthogonalization and correlation of GS matrix/KL matrix and reduction to zero of low eigenvalued eigenvectors, the so-reduced GS/KL matrix and any meta data is prepared for transmission. The data is then arithmetically encoded and a file written in memory for the particular subimage.

At each stage of the compression of the data, different parameters are tried and compared and an optimal technique minimizing the sum of the entropies of the transformed and correlated data is calculated.

An averaging technique is used to make the prediction by taking the brightness differences, comparing them to the mean of selected neighboring values and creating a brightness prediction. When the image pixels have multiple data for different colors, the data in different color planes are compared as well. A prediction model is chosen based upon the brightness difference from the mean brightness value. In the filtering component. HSL, HSV and wavelength variance from distinct points on the subarray are selected to update the filters for the next block of information.

The distribution of the data values is compared to the distribution of values of the prediction and the variances from block to block of the second transform are compared. The resulting combination of prediction and filtering of separate parameters and different transforms creates a smaller distribution than the original data. The process is repeated for each of the planes of data. The different planes of the same pixel are not used entirely independently by one transform, but are covered by varying the measurements taken and the method of transformation on the same data set.

To decompress the data, the GS data is added back to the reversal of the KS data restoring all or most of the transformed data depending upon the desired result of the user.

By exploiting parallelism at both the instruction and data level, the present invention is able to achieve real-time throughput rates. Instruction level parallelism is achieved using a technique known as multithreading where different parts of the same algorithm can be executed concurrently, and their intermediate results are shared through software thread synchronization mechanisms. A CODEC run on several groups of 12-core nodes may be employed. Data level parallelism is achieved by running the same multithreaded code on several frames in parallel on different groups of processor nodes. This process may be further broken down by pipelining in deeper layers the operations on a single image; thus multiple processors and multiple threads per processor can work concurrently on portions of the same image.

To achieve real-time performance, I/O bandwidth from disk arrays needs to be matched with the necessary frame rate. E.g. 24 fps of 50 MB frames translate to roughly 1.2 GB/s throughput on the storage subsystem. Storage can be structured hierarchical to support high throughput using a combination of fast/expensive (such as Solid State Drives) together with slower/cheaper striped disk arrays. A Virtual File Operation System (such as CXSF) provides a means to map the storage for different groups of processors to the same physical storage array.

The above approach can be implemented even more efficiently and directly in hardware, by mapping to hardware platforms, including Integrated Circuits (IC) for low cost high volume applications; Field Programmable Gate Arrays (FPGA) for medium cost low volume applications (using Xilinx or Altera families of FPGAs); and Multicore GPGPU (General Purpose GPUs such as NVIDIA Tesla and Fermi families) for lower cost high volume applications. The hardware organization of the parallel/pipelined compression engine comprises a Stream Distributor/Aggregator that distributes subunits of input data (frames, etc.) to one of several compression pipelined engines and aggregates the encoded substreams into an output stream. Each compression pipelined engine consists of a Prediction (Pr) stage, an Adaptive Selection (AS) stage and a Coding from Symbol Table (CST) stage.

Integrated circuits provide the most direct and efficient implementation at the expense of long design cycle and high development costs. Field programmable gate arrays provide an efficient and fast route to implementation at the expense of higher unit cost but much lower development costs. General purpose computation on graphics processing units provides the fastest and most flexible solution based on available multicore devices programmable in C/C++, at a somewhat less parallel implementation. A combination of CPU and GPU cores may provide a cost effective solution by separating the subroutines of the software onto the cores best suited for each calculation—-such as adds, subtracts, and compares for CPUs and multiplies and divides for CPUs.

One possible implementation is the SGI Iceberg implementation comprising 128 nodes, each with 8 Xeon cores (1024 cores total); 3 GHz clock speed; an on-board local memory: 32 GB/node, 4 TB total, and a SuSE Linux operating system with a PBSPro queuing system.

While the invention has been described in terms of preferred embodiments, those skilled in the art will recognize that the invention can be practiced with modifications within the spirit and scope of the appended claims. In particular, although the invention describes lossless encoding, use of the invention accompanied by variation to accept some loss would still be within the scope of the invention.

What is claimed is:

1. A system for transforming an image for display on a hardware platform by the method for compressing raster graphics images in a rectangular grid of pixels defined in RGB or more color spaces of planes of bytes comprising the steps of
performing a first KL transform step on each plane of bytes;
constructing an additional color plane;
sending a subspace of data from the KL transform to the additional color plane;
performing in parallel a Gram-Schmidt (herein “GS”) transform on at least a subset of the data in the additional color plane;
wherein the subspace of data comprises a raster that is a combination of a zeroed out color plane and elements that are discarded from the KL transform and mapped to the additional color plane.

2. The system for transforming an image of claim 1, further including the pre-processing steps of
reading a data file, and extracting its metadata;
dividing data from the data file into subimages and processed the data into blocks of a uniform size;
replacing a portion of the data by predictive values subject to adjustable parameters and the deviations from the predictive values.

3. The system for transforming an image of claim 2, wherein
the predictive values are obtained by an edge detection of each block and the adjustable parameters are the block dimensions and other parameters characterizing the method of prediction.

4. The system for transforming an image of claim 3, further comprising
calculating the entropy of the data formed by different methods of prediction and utilizing the method that produces the least entropy.

5. A system for transforming an image executing the compression of data by the steps of
performing a first KL transform step on each plane of bytes comprising
the computation of a KL matrix, which comprises the eigenvectors of an autocorrelation matrix;
determining the eigenvectors and eigenvalues of the matrix;
quantizing the matrix by the removal of the subspace of lower eigenvalue elements;
selecting a subset of eigenvalues and putting the matrix values from the KL transform corresponding to the suppressed eigenvalues into a plane
padding with zeros the suppressed eigenvector values of the KL matrix corresponding to the selected eigenvalues.

6. The system for transforming an image according to claim 5, wherein the selected subset of eigenvalues comprise the smallest eigenvalues of the KL matrix;
repeating the method by reducing the KL matrix by removing the eigenvectors corresponding to successively larger eigenvalues;
at each stage calculating the entropy of the resulting data; plus the entropy of the values discarded from the KL but transformed by the GS transform; and
transmitting as the compressed file the one with the lowest sum of entropies.

7. The system for transforming an image of claim 5 further comprising the steps of
subjecting different blocks of the KL transformed data to a reverse transformation;
comparing the result of the reverse transformation to the original data and forming difference data;
calculating the entropy of the original data and the entropy of the difference data;
selecting for transmission the data with the lower entropy;
in parallel, performing a GS transform after the first n rows of the KL transform matrix are determined;
removing image data from the KL matrix;
performing an induction step to form an orthonormal set with linear independence;
repeating this last process step one or more times to generate a set of basis vectors;
combining the result with the reduced KL matrix to increase fully or slightly the dimensionality of the transformed data.

8. The system for transforming an image of claim 7 wherein the dimensionality of the original data is fully restored and the transformation is lossless.

9. The system for transforming an image of claim 7, wherein the dimensionality of the original data is not fully restored and the transformation is lossy.
